(19) United States
(12) Patent Application Publication
(10) Pub. No.: US 2022/0048101 A1
(43) Pub. Date: Feb. 17, 2022

(54) METHOD FOR MONITORING A TORPEDO CAR AND A TORPEDO CAR MONITORING SYSTEM

(71) Applicant: TMT - Tapping Measuring Technology GmbH, Siegen (DE)

(72) Inventors: Volker Langer, Siegen (DE); Alexander Grenz, Netphen (DE)

(21) Appl. No.: 17/398,143

(22) Filed: Aug. 10, 2021

(30) Foreign Application Priority Data
Aug. 12, 2020 (DE) 10 2020 121 242.9

(51) Int. Cl. B22D 2/00; G06K 19/07

(52) U.S. Cl. CPC B22D 2/003; B22D 2/006; G06K 19/0723

(57) ABSTRACT

A method for monitoring a torpedo car in which a position detector PE is used to determine a position deviation between a target position and an actual position of a filling opening E of the torpedo car disposed in a filling station BS for filling it with pig iron and provided with an RFID transponder containing an object data set for identification, the filling opening E is positioned in the target position in the event of a position deviation, the filling level FM in the torpedo car disposed in the target position is measured by means of a filling level meter FM, the temperature of the pig iron filled into the filling opening is measured by means of a temperature meter TM, and data characterizing the position deviation, the filling level and the temperature is added to the object data set of the torpedo car by means of a data processor DV.

This application claims the benefit of German Patent Application No. 10 2020 121 242.9, filed on Aug. 12, 2020, the disclosure of which is incorporated herein by reference.

### TECHNICAL FIELD

The present invention relates to a method for monitoring a torpedo car in which a position detector is used to determine a position deviation between a target position and an actual position of a filling opening of the torpedo car disposed in a filling station for filling it with pig iron and provided with an RFID transponder containing an object data set for identification, the filling opening is positioned in the target position in the event of a position deviation, the filling level in the torpedo car disposed in the target position is measured by means of a filling level meter, the temperature of the pig iron filled into the filling opening is measured by means of a temperature meter, and data characterizing the position deviation, the filling level and the temperature is added to the object data set of the torpedo car by means of a data processor.

### SUMMARY

Moreover, the invention relates to a torpedo car monitoring system comprising an identification device for identifying the torpedo car, a position detector for detecting the position of the torpedo car in a filling station for filling it with pig iron, a filling level meter for measuring the pig iron filling level in the torpedo car, a temperature meter for measuring the pig iron temperature, and a data processor for calculating a position deviation of an actual position relative to a target position of the torpedo car and entering the data characterizing the position deviation, the filling level and the temperature into the object data set of the torpedo car.

Torpedo cars are used to transport liquid pig iron, which is filled into a filling opening of the torpedo car in a filling station of a steel mill via a runner-shaped filling device. Torpedo cars are provided with a fireproof brick lining, which allows the filled-in pig iron to be thermally insulated from the environment of the torpedo car and provides temperature protection for the steel casing of the torpedo car. Hence, the condition of the fireproof brick lining is of great importance in particular for the operational safety of torpedo cars, which means that repeated monitoring of the state of the fireproof brick lining is imperative and repairs are to be made as required in order to prevent undesired temperature losses during the transport of the pig iron and to preclude the risk of pig iron leakage due to component failure.

Hence, the monitoring of the condition of the fireproof brick lining of torpedo cars is of great importance in practice in order to be able to perform maintenance on or replace the fireproof brick lining in time if required and provide a replacement for the torpedo car in need of repair.

In the interest of a continuous use of the torpedo cars, the monitoring of the condition of the fireproof brick lining of the torpedo car should not require the use of the torpedo cars to be interrupted.

### FIELD OF THE INVENTION

Hence, the object of the present invention is to propose a method and a device for monitoring torpedo cars which can be implemented without disrupting the operation of the torpedo cars.

In the method according to the invention for monitoring a torpedo car, a position detector is used to determine a position deviation between a target position and an actual position of a filling opening of the torpedo car disposed in a filling station for filling it with pig iron and provided with an RFID transponder containing an object data set for identification, the filling opening is positioned in the target position in the event of a position deviation, the filling level in the torpedo car disposed in the target position is measured by means of a filling level meter, the temperature of the pig iron filled into the filling opening is measured by means of a temperature meter, and data characterizing the position deviation, the filling level and the temperature are added to the object data set by means of a data processor.

Thus, the method according to the invention allows the parameters essentially responsible for the condition or the wear of the fireproof brick lining of the torpedo car to be detected during the stay of the torpedo car in the filling station and in particular during the filling process, i.e., in situ, which means that the operation of the torpedo car does not have to be interrupted in order to be able to draw conclusions as to the condition of the fireproof brick lining.

Moreover, the method according to the invention allows a sort of torpedo car log to be kept by linking said parameters, which allows the use history or the operation history of the torpedo car individualized through the RFID transponder to be tracked in order to be able in particular to assess the quality of the fireproof brick lining used.

The position detector employed in the method according to the invention allows the relative position of the filling opening of the torpedo car relative to the filling device of the filling station, which is typically a tilting runner, to be monitored and additionally enables a reproducible relative arrangement which ensures not only that the filled-in pig iron enters the torpedo car without coming into contact with the edge of the filling opening, if possible, but also that the filling opening is positioned relative to the filling direction as a prerequisite for an exact filling level measurement by means of a beam path incident on the surface of the filled-in volume with the result that the edge of the filling opening or pig iron deposits formed on the edge can largely be precluded from interfering with the beam path.

It is particularly advantageous if the data processor DV calculates the position deviation as a difference between the target position and the actual position of the filling opening E and transmits the position deviation to a controller SE for positioning the torpedo car TW in the target position as a correcting variable.

It has proven particularly advantageous for the position detector to be designed as a laser scanner operated in pulsed measuring mode, i.e., a laser scanner which measures the time between the emission and the reception of light pulses reflected from the surface of the torpedo car with the result that the position and the size of the filling opening in the surface of the torpedo car can be determined based on differences in travel time.

The filling level is preferably measured using a radar probe, the filling level values measured by the filling level meter being added to the individualized object data set via the data processor as described above.

Pyrometers allowing a suitable distance to be maintained between the temperature meter and the liquid pig iron can be advantageously used for temperature measuring. Preferably, the temperature is measured on an outpour leaving the filling device immediately before it enters the filling opening.

In an implementation of the method as simple as possible, the data processor essentially serves only to receive the measuring data determined by the position detector, the filling level meter and the temperature meter and to transmit said measuring data to the RFID transponder of the torpedo car. In a particularly advantageous embodiment, the data processor additionally serves to execute an algorithm defining a performance characteristic for the fireproof brick lining from the determined data and assigning said performance characteristic to the individualized data set of the torpedo car with the result that by simply knowing said performance characteristic, the skilled person can decide whether the fireproof brick lining of the torpedo car requires maintenance or repair.

In addition, the method according to the invention can involve determining the weight of the torpedo car or rather the weight difference between the weight of the filled torpedo car and the empty weight in order to be able to determine a loss of mass of the fireproof brick lining. This is based on the assumption that a loss of mass of the fireproof brick lining leads to an increase in empty weight since defects of the fireproof brick lining are filled with deposits of pig iron. The weight can in particular be determined directly by weighing or based on the geometry of the contained interior and by measuring the pig iron filling level.

The torpedo car monitoring information system according to one aspect of the invention comprises as components an identification device designed as an RFID transponder for identifying a torpedo car, a position detector for detecting the position of the torpedo car in a filling station for filling the torpedo car with pig iron, a filling level meter for measuring the pig iron filling level in the torpedo car, a temperature meter for measuring the pig iron temperature, and a data processor for calculating a position deviation of an actual position relative to a target position of the torpedo car and entering the data characterizing the position deviation, the filling level and the temperature into the object data set of the torpedo car.

Preferably, the identification device comprises the RFID transponder installed on the torpedo car and containing a data set individualizing the torpedo car, and at least one reader/writer installed adjacent to the torpedo car.

Preferably, the position detector comprises a sensor device for detecting the relative position of a filling opening of the torpedo car below a filling device of the filling station.

It is particularly advantageous if the sensor device is designed as a laser scanner operated in pulsed mode and disposed in the filling station at a position above the filling opening of the torpedo car.

It is particularly preferred if the filling level meter is designed as a radar measuring device.

Preferably, the position detector, the filling level meter and the temperature meter are connected to the data processor via data connections.

### BRIEF DESCRIPTION OF THE DRAWINGS

Hereinafter, a preferred embodiment of the invention will be explained in more detail with reference to the drawing.

FIG. 1 is a block diagram illustrating an embodiment of the invention;

FIG. 2 shows a feeding plane of a filling station disposed above a torpedo car including a possible arrangement of components used for operating the torpedo car monitoring system;

FIG. 3 shows a torpedo car disposed below the feeding plane.

### DETAILED DESCRIPTION OF THE INVENTION

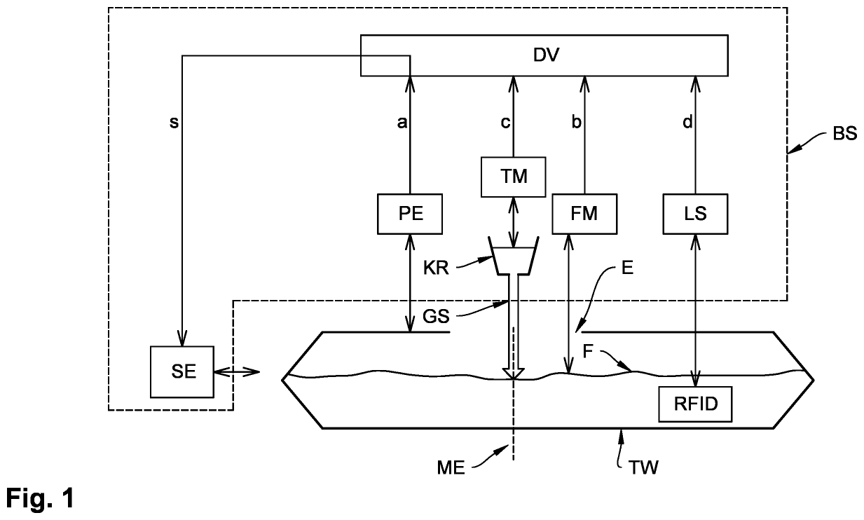

FIG. 1 shows a schematic illustration of a torpedo car TW in a filling station BS at the time of a filling with pig iron, which is filled into torpedo car TW through a filling opening E from a tilting runner KR and forms a filling level F therein, for illustrating a possible embodiment of the method. Torpedo car TW is equipped with an RFID transponder, which allows torpedo car TW to be identified by means of a reader/writer LS disposed on the filling station. In addition to reader/writer LS, filling station BS comprises a position detector PE, a filling level meter FM, a temperature meter TM and an actuator SE.

Position detector PE is designed as a laser scanner, light pulses being modulated onto a carrier wave in pulsed mode and the time between the emission and the reception being measured. The carrier wave scans the surface of torpedo car TW, allowing the effective filling opening actually formed in the surface of the torpedo car to be precisely located.

Pig iron deposits formed at the opening edge of filling opening E because of the repeated use of the torpedo car can lead to significant deviations between the opening edge constructively defined on the torpedo car and the actually formed opening edge, said deviations being detected by the position detector with the result that a data processor DV can calculate position deviations between a center axis of the constructively defined filling opening E and a center axis ME of the effective filling opening E as a function of output signal a of the position detector and can transmit them as control signals to an actuator SE, by means of which the position can be readjusted in such a manner that center axis ME coincides with an outpour GS pouring from tilting runner KR into torpedo car TW. In this position, the function of a filling level meter FM is enabled by position detector PE, allowing filling level meter FM, which is preferably designed as a radar device, to measure the distance between a horn antenna disposed at filling station BS and the liquid surface in torpedo car TW and data processor DV to calculate filling level F therefrom.

The temperature of outpour GS, i.e., the temperature of the pig iron as it enters torpedo car TW, can be measured using temperature meter TM, which is preferably designed as a pyrometer. Output signal c of temperature meter TM is transmitted to data processor DV, as are output signal b of filling level meter FM and output signal a of position detector PE, allowing data processor DV, which is disposed at filling station BS or can also be disposed anywhere outside of filling station BS and be connected via data connections, to transmit data generated from the output signals, such as characteristics calculated from the output signals, to reader/writer LS in order to amend an object data set stored on the RFID transponder, or allowing a performance characteristic to be calculated based on the data or characteristics using a suitable algorithm in data processor DV and said performance characteristic to be subsequently stored on the RFID transponder.

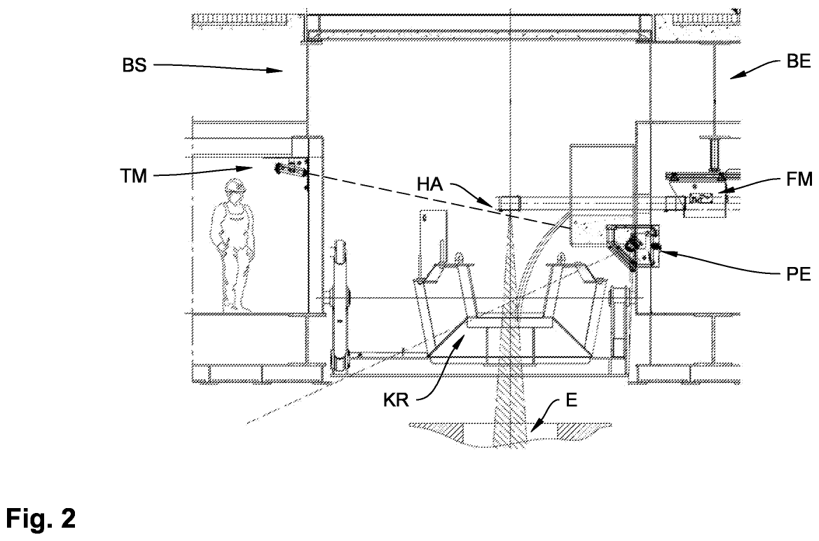

FIG. 2 shows a possible installation of position detector PE, filling level meter FM and temperature meter TM of the torpedo car monitoring system at a filling station BS, filling level meter FM, which is provided with a horn antenna HA displaceable parallel to the drawing plane, temperature meter TM, the beam path of a pyrometer of which is directed at outpour GS, and position detector PE being disposed in a feeding plane BE of filling station BS, in which tilting runner KR is disposed.

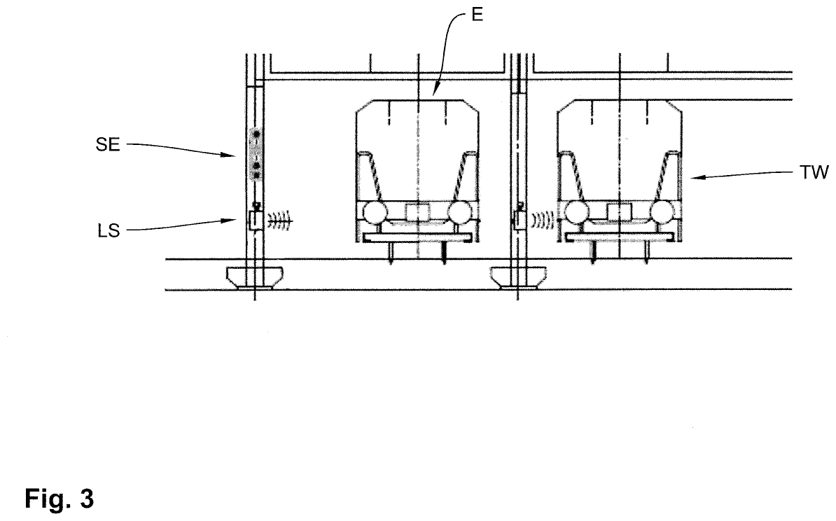

As shown in FIG. 3, torpedo car TW, whose filling opening E is disposed below outpour GS, is located below feeding plane BE. Reader/writer LS, which communicates with the RFID transponder installed on torpedo car TW, is also disposed below feeding plane BE. Furthermore, actuator SE, which can comprise a drive acting on torpedo car TW or which can also be designed as a display in order to display the actuation path to be executed in order to correctly position filling opening E, is provided adjacent to the torpedo car.

1. A method for monitoring a torpedo car TW in which a position detector PE is used, comprising: determining a position deviation between a target position and an actual position of a filling opening E of the torpedo car TW disposed in a filling station BS for filling it with pig iron and provided with an RFID transponder containing an object data set for identification, the filling opening E is positioned in the target position in the event of a position deviation, measuring the filling level FM in the torpedo car TW disposed in the target position by means of a filling level meter FM, measuring the temperature of the pig iron filled into the filling opening by means of a temperature meter TM, and data characterizing the position deviation, and adding the filling level and the temperature to the object data set of the torpedo car TW by means of a data processor DV.

2. The method according to claim 1, wherein the data processor DV calculates the position deviation as a difference between the target position and the actual position of the filling opening E and transmits the position deviation to a controller SE for positioning the torpedo car TW in the target position as a correcting variable.

3. A torpedo car monitoring system comprising: an identification device for identifying the torpedo car TW, a position detector PE for detecting the position of the torpedo car TW in a filling station BS for filling it with pig iron, a filling level meter FM for measuring the pig iron filling level in the torpedo car TW, a temperature meter TM for measuring the pig iron temperature, and a data processor DV for calculating a position deviation of an actual position relative to a target position of the torpedo car TW and for entering the data characterizing the position deviation, the filling level and the temperature into the object data set of the torpedo car TW.

4. The torpedo car monitoring system according to claim 3, wherein the identification device comprises the RFID transponder installed on the torpedo car and at least one reader/writer LS installed adjacent to the torpedo car TW.

5. The torpedo car monitoring system according to claim 3, wherein the position detector PE comprises a sensor device for detecting the relative position of a filling opening of the torpedo car below a filling device of the filling station BS.

6. The torpedo car monitoring system according to claim 5, wherein the sensor device is designed as a laser scanner operated in pulsed mode and disposed in the filling station in a position above the filling opening E of the torpedo car TW.

7. The torpedo car monitoring system according to claim 3, wherein the filling level meter FM is designed as a radar device.

8. The torpedo car monitoring system according to claim 3, wherein the position detector PE, the filling level meter FM and the temperature meter TM are connected to the data processor DV via data connections.
